(19) United States
(12) Patent Application Publication
(10) Pub. No.: US 2026/0340476 A1
(43) Pub. Date: Oct. 29, 2026

(54) GENERATING HEURISTICS USING WEAKLY-SUPERVISED MACHINE LEARNING AND DIGITAL TWIN SIMULATIONS

(71) Applicant: NEC Laboratories Europe GmbH, Heidelberg (DE)

(72) Inventors: Gurkan SOLMAZ, Heidelberg (DE); Flavio CIRILLO, Heidelberg (DE)

(21) Appl. No.: 19/103,847

(22) PCT Filed: Jun. 23, 2023
(86) PCT No.: PCT/IB2023/056499

§ 371 Date: Feb. 14, 2025

Related U.S. Application Data
(60) Provisional application No. 63/454,977, filed on Mar. 28, 2023.

(51) Int. Cl. G06N 20/00; G06N 5/01; G06N 5/022

(52) U.S. Cl. CPC G06N 20/00; G06N 5/01; G06N 5/022

(57) ABSTRACT

A computer-implemented method for generating and/or adjusting a heuristic function for a machine learning prediction. A machine learning prediction task including a target entity and attribute is received. Semantic relations are explored to generate relevant entities and attributes related to the target entity and attribute. The heuristic function is generated and/or adjusted based on the relevant entities and attributes.

### CROSS-REFERENCE TO RELATED APPLICATIONS

This application is a U.S. National Phase application under 35 U.S.C. § 371 of International Application No. PCT/IB2023/056499, filed on Jun. 23, 2023, and claims benefit to U.S. Provisional Patent Application No. 63/454,977, filed on Mar. 28, 2023, the entire disclosure of which is hereby incorporated by reference herein. The International Application was published in English on Oct. 3, 2024 as WO 2024/201122 A1 under PCT Article 21(2).

### FIELD

The present invention relates to artificial intelligence (AI) and machine learning, and in particular to a method, system and computer-readable medium for creating heuristics or guiding heuristic generation, and to a method, system and computer-readable medium for completing missing information in digital twins using weakly-supervised machine learning.

### BACKGROUND

Digital twins are virtual representations of a physical product, system, and/or process and can be used in a variety of industries and applications. The virtual representation serves as a digital counterpart of a real-world product, system and/or process to facilitate various purposes, including simulation, integration, testing, monitoring, and maintenance.

Maintenance of an accurate digital twin or system of digital twins is important to ensure physical counterparts are monitored and/or operated as intended and that simulations performed using digital twins provide accurate predictions.

### SUMMARY

In an embodiment, the present invention provides a computer-implemented method for generating and/or adjusting a heuristic function for a machine learning prediction, comprising receiving a machine learning prediction task including a target entity and attribute. Semantic relations are explored to generate relevant entities and attributes related to the target entity and attribute. The heuristic function is generated and/or adjusted based on the relevant entities and attributes.

### BRIEF DESCRIPTION OF THE DRAWINGS

Embodiments of the present invention will be described in even greater detail below based on the exemplary figures. The present invention is not limited to the exemplary embodiments. All features described and/or illustrated herein can be used alone or combined in different combinations in embodiments of the present invention. The features and advantages of various embodiments of the present invention will become apparent by reading the following detailed description with reference to the attached drawings which illustrate the following:

FIG. 1 schematically illustrates a method of using a digital twin for simulations to gain insights;

FIG. 2 schematically illustrates weak supervision for digital twin feature completion using labeling function creation by experts;

FIG. 3 schematically illustrates a method and system for digital twin simulation for generating or guiding heuristics creation or adjustment, and for missing feature completion according to an embodiment of the present invention;

FIG. 4 schematically illustrates a method and system for recommendation and guidance of weak supervision using a semantic model of a building digital twin according to an embodiment of the present invention;

FIG. 5 schematically illustrates a method and system for making a weak supervision recommendation for abstract and instant-level heuristics according to an embodiment of the present invention;

FIG. 6 schematically illustrates a method and system for weak supervision guidance including a developer interface for suggestions to adjust heuristics in the weak supervision according to an embodiment of the present invention;

FIG. 7 schematically illustrates a semantic weak supervision pipeline for generating abstract heuristic functions according to an embodiment of the present invention;

FIG. 8 schematically illustrates a digital twin-guided weak supervision pipeline for instantiation of heuristic functions according to an embodiment of the present invention;

FIG. 9 schematically illustrates utilizing digital twin data for the discovery of digital twin semantics according to an embodiment of the present invention;

FIG. 10 schematically illustrates a digital twin-guided weak supervision pipeline for heuristic guidance in the form of proposal of new functions according to an embodiment of the present invention;

FIG. 11 schematically illustrates a digital-twin guided weak supervision pipeline for heuristic guidance in the form of adjusting existing functions according to an embodiment of the present invention;

FIG. 12 schematically illustrates a semantic graph of a building digital twin showing only two rooms to provide a simplified view for ease of understanding;

FIG. 13 illustrates a method for predicting missing digital twin values; and

FIG. 14 is a block diagram of an exemplary processing system, which can be configured to perform any and all operations disclosed herein.

### DETAILED DESCRIPTION

Embodiments of the present invention provide a method and system for digital twin-guided machine learning. In some embodiments, digital twin-guided machine learning is used for smart districts and smart buildings. The method and system utilize digital twin information such as data and ontology to automatically create machine learning models with a weak supervision machine learning pipeline.

As a result, the accuracy of weakly-supervised machine learning models for carrying out prediction tasks can be improved, leading to further improvements in the efficiency of machine learning computer systems, as increased accuracy reduces the need for repeated computations. Embodiments of the present invention also provide increased scalability of weakly-supervised machine learning models, as time and resource intensive manual machine learning model adjustments can be automated, allowing a developer to supervise more models and also allowing models to incorporate more data and ontologies without overwhelming the developer.

In some embodiments, digital twin-guided machine learning is used for smart districts and smart buildings. Embodiments of the present invention are also applicable to a variety of fields where digital twin-guided machine learning may be used, such as in smart hospitals or more generally in the medical field where digital twins may be used to model physical counterparts for the purpose of patient diagnosis, predicting treatment plans for a patient, predicting the length of stay of a patient in a care facility, and developing drugs and/or vaccines.

Digital twins are considered for their large-scale applications, e.g., to urban scenarios such as smart cities (see Martin Bauer, Flavio Cirillo, Jonathan Fürst, Gürkan Solmaz, and Ernö Kovacs, “Urban digital twins-a fiware-based model,” at-Automatisierungstechnik 69, no. 12, pp. 1106-1115 (2021), which is hereby incorporated by reference herein). In particular, digital twins can be used to simulate and to predict situations in smart cities. For instance, various “what-if” scenarios can be simulated thanks to the help of digital twins. Although simulation technologies are considered in the context of digital twins, there is not a common and straight-forward way of applying the simulations or machine learning as this can depend on the application needs. In other words, for each vertical application, a different set of systems or simulation/machine learning pipelines can be applied, based on the vertical needs.

A first aspect of the present invention provides a computer-implemented method for generating and/or adjusting a heuristic function for a machine learning prediction, comprising receiving a machine learning prediction task including a target entity and attribute. Semantic relations are explored to generate relevant entities and attributes related to the target entity and attribute. The heuristic function is generated and/or adjusted based on the relevant entities and attributes.

According to a second aspect, the present invention provides the method according to the first aspect, wherein the semantic relations are explored using an ontology graph comprising entities, attributes and relationships, and ontology descriptions of the entities and attributes in the ontology graph.

According to a third aspect, the present invention provides the method according to the first or second aspect, wherein the relevant entities and attributes are used to create abstract heuristic functions comprising to be determined values that are presented to a weak supervision recommender application programming interface (API) by performing steps. The steps include ranking the relevant entities and attributes based on distance from the target entity and attribute and using closest ones of the relevant entities and attributes as input arguments of a programming function. The steps also include filling the programming function from a template using the input arguments added with cases in comparison with the to be determined values and presenting the cases and the to be determined values to the weak supervision recommender API.

According to a fourth aspect, the present invention provides the method according to any of the first to third aspects, further comprising receiving values for the to be determined values, and instantiating the abstract heuristic functions as instance heuristic functions using the received values. The method is repeated to determine a plurality of the instance heuristic functions which provide initial predictions combined by a machine learning model to make the machine learning prediction.

According to a fifth aspect, the present invention provides the method according to any of the first to fourth aspects, further comprising using the relevant entities and attributes to query a digital twin graph and outputting results of the query to a machine learning model trained to predict entities and attributes related to the relevant entities and attributes. The abstract heuristic functions are instantiated as instance heuristic functions using predicted thresholds from the machine learning model and the to be determined values are replaced with the predicted thresholds. The digital twin graph includes data from a digital twin comprising measurements obtained from one or more sensors According to a sixth aspect, the present invention provides the method according to any of the first to fifth aspects, wherein the weak supervision recommender API is configured to allow a user to accept or reject the abstract heuristics, or to fill in the to be determined values.

According to a seventh aspect, the present invention provides the method according to any of the first to sixth aspects, further comprising receiving previously implemented heuristics with threshold values. The threshold values of the previously implemented heuristics are compared with predicted threshold values determined using digital twin processing with the relevant entities and attributes. The previously implemented heuristics are adjusted based on the comparison of the threshold values of the previously implemented heuristics with the predicted threshold values.

According to an eighth aspect, the present invention provides the method according to any of the first to seventh aspects, wherein the generated and/or adjusted heuristic function is an instance heuristic function used by a weakly-supervised machine learning model to predict a missing value of a digital twin.

According to a ninth aspect, the present invention provides the method according to any of the first to eighth aspects, wherein the missing value of the digital twin is filled in with the prediction, and wherein the method is iteratively repeated until all missing values of the digital twin have been predicted and filled in.

According to a tenth aspect, the present invention provides the method according to any of the first to ninth aspects, wherein generating and/or adjusting the heuristic function is based on data from the digital twin.

According to an eleventh aspect, the present invention provides the method according to any of the first to tenth aspects, wherein the data from the digital twin includes measurements received from sensors of a smart building and the machine learning prediction is for one or more of an occupancy, temperature, humidity, carbon dioxide level, and heating level of one or more rooms of the smart building.

According to a twelfth aspect, the present invention provides the method according to any of the first to eleventh aspects, further comprising receiving previously implemented heuristics. Entities and attributes of the previously implemented heuristics are compared with the relevant entities and attributes. Adjusted heuristics are generated based on the comparison of the entities and attributes of the previously implemented heuristics with the relevant entities and attributes.

According to a thirteenth aspect, the present invention provides the method according to any of the first to twelfth aspects, wherein comparing the entities and attributes of the previously implemented heuristics with the relevant entities and attributes includes building a decision tree for each of the previously implemented heuristics and based on each of the relevant entities and attributes and comparing the built decision trees.

In a fourteenth aspect, the present invention provides a computer system comprising one or more processors which, alone or in combination, are configured to provide for execution of the method for generating and/or adjusting a heuristic function for a machine learning prediction according to any of the first to thirteenth aspects.

In a fifteenth aspect, the present invention provides a non-transitory computer-readable medium having processor-executable instructions stored thereon, wherein the processor-executable instructions, when executed by one or more processors, facilitate performance of the method for generating and/or adjusting a heuristic function for a machine learning prediction according to any of the first to thirteenth aspects.

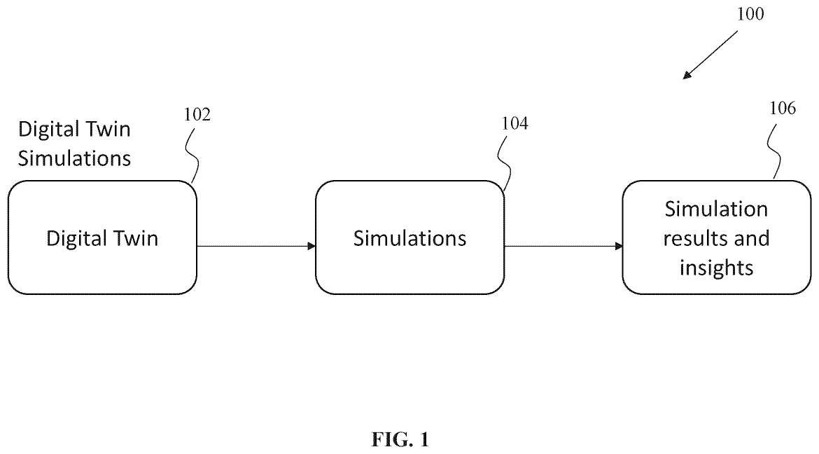

Referring to FIG. 1, a method 100 of using a digital twin 102 for simulations to gain insights is illustrated. The digital twin 102 is a virtual counterpart to a physical product, system, and/or process and can be used to carry out a simulation 104 of what would happen in the physical counterpart. The simulation 104 advantageously provides results and insights 106 that may be used to predict outcomes in the physical counterpart of the digital twin 102. Thus, the digital twin 102 enables digital simulations that do not require real-world physical simulations conducted with the physical counterpart that may otherwise detrimentally affect the physical counterpart (e.g., by causing wear or damage to the physical counterpart) or interrupting operation of the physical counterpart.

Various machine learning models have been considered for applications in smart districts such as smart cities or smart mobility. For instance, autonomous vehicles can leverage machine learning through pre-trained (supervised) high-accuracy machine learning architectures such as deep learning for image recognition. On the other hand, these architectures rely highly on having large amounts of ground-truth data for training deep machine learning models. Without a large dataset with ground-truth labels, it is very difficult for the machine learning models such as deep neural network architectures to converge and provide useful outcomes, e.g., for situations happening in smart districts.

As an alternative to fully-supervised machine learning, weak supervision is based on relying on either partial or unreliable data sources for supervision of the machine learning. The weak supervision sources can be remote data sources through crowdsourcing or could be a set of rules, also referred to as heuristics, that are implemented by developers. For heuristics, Alexander J. Ratner, Christopher De Sa, Sen Wu, Daniel Selsam, and Christopher Ré, “Data Programming: Creating Large Training Sets, Quickly,” Advances in neural information processing systems 29, arXiv: 1605.07723 (2016), which is hereby incorporated by reference herein, describes a “data programming” approach that provides an interface for creating the set of rules (heuristics) as “labeling functions” where the labeling function should be developed either by data scientists, domain experts or a group consisting of both.

Thus, this data programming approach considers creation of weak supervision manually by experts with programming knowledge. There is no way of automatic creation of labeling functions disclosed.

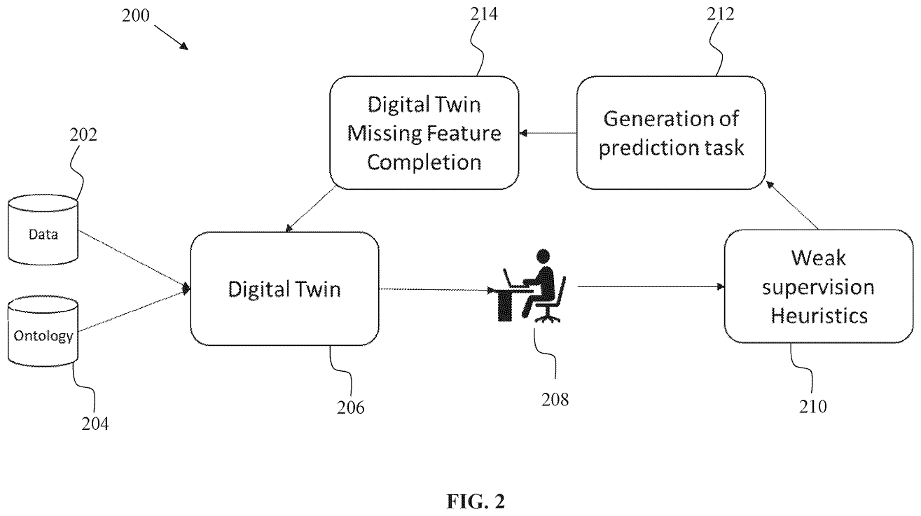

Referring to FIG. 2, a method 200 for weak supervision for digital twin feature completion using labeling function creation by experts is illustrated. Data 202 and one or more ontologies 204 are provided to a digital twin 206. The data 202 and one or more ontologies 204 provided to the digital twin 206 are used by one or more experts 208 to create weak supervision heuristics 210. The one or more experts 208 may include data scientists, domain experts or a group consisting of both. The weak supervision heuristics 210 may include a set of rules, such as labeling functions. The weak supervision heuristics 210 are then used for generation of a prediction task 212. The generated prediction task 212 is used to update the digital twin by providing features missing from the digital twin, thereby leading to digital twin missing feature completion 214.

According to existing approaches, labeling function creation requires expertise in a certain domain, good programming and data science knowledge, as well as time and effort of experts in addition to computational resources. These resources are necessary to implement a working machine learning model with a satisfactory number and “quality” of labeling functions where quality may involve metrics such as accuracy and dataset coverage. On the other hand, in most scenarios, these resources are both hard to bring together, if not impossible, due to the interdisciplinary nature of various industries and business domains.

Furthermore, acquiring ground-truth data is either not possible or very technically challenging, time consuming and resource intensive, especially considering the specific scenario/environment and many possible tasks or subtasks.

Oishik Chatterjee, Ganesh Ramakrishnan, and Sunita Sarawagi, “Robust data programming with precision-guided labeling functions,” Proceedings of the AAAI Conference on Artificial Intelligence, Vol. 34, No. 04(2020 ), which is hereby incorporated by reference herein, consider using weak supervision for semantic parsing of information from multiple domains, but there is no mention of automatically creating or guiding weak supervision through semantic annotations.

Priyanka Agrawal, Parag Jain, Ayushi Dalmia, Abhishek Bansal, Ashish Mittal, and Karthik Sankaranaray anan, “Unified semantic parsing with weak supervision,” arXiv: 1906.05062 (2019), which is hereby incorporated by reference herein, consider using weak supervision for a “semantic parser” which targets understanding semantic context from content such as text files, but there is no mention of automatically creating labeling functions.

Paroma Varma and Christopher Ré, “Snuba: Automating weak supervision to label training data,” Proceedings of the VLDB Endowment, International Conference on Very Large Data Bases, Vol. 12, No. 3, NIH Public Access (2018), which is hereby incorporated by reference herein, consider automatic creation of labeling functions. However, the study considers using a small “labeled dataset” that makes it not a weak supervision approach, but rather a hybrid approach (semi-supervised) between fully-supervised and weakly-supervised. Moreover, the study requires and assumes the existence of ground-truth data availability. Another approach by Applicant considers using active learning as a small labeled data for guiding the weak supervision sources, but assumes a manual process to provide ground-truth labels.

Jason A. Fries, Ethan Steinberg, Saelig Khattar, Scott Fleming, Jose Posada, Alison Callahan, and Nigam Shah, “Ontology-driven weak supervision for clinical entity classification in electronic health records,” Nature communications 12.1:2017 (2021), which is hereby incorporated by reference herein consider making use of ontologies for understanding texts (strings) in the medical domain. Making use of digital twins does not require text understanding, but it requires data-driven correlations between entities in the smart district.

Embodiments of the present invention provide solutions to the technical problem of how to generate machine learning models without having a large set of ground truth data. In particular, according to existing technology, generation of machine learning models requires a large amount of ground truth data which is usually time and resource intensive to collect. Although, one solution would be the adoption of weak supervision techniques that use heuristics to programmatically generate ground truth, creation of these heuristics is still time and resource intensive, especially when there is lack of domain knowledge. Domain knowledge may include, for example, know-how or procedural knowledge required for configuring proprietary technology, abbreviations used in a particular industry, pattern recognition in a specialized application, or other general background knowledge of a field or environment that applies to data. Embodiments of the present invention advantageously overcome these technical problems by automatically creating and guiding creation of input and output features without the existence of ground-truth data and by leveraging digital twin simulations. Such a solution to the technical problem of automatically creating or guiding data sources enables to avoid the time and resource intensive collection of ground truth data, while saving computational time and resources as well, and even enables creating machine learning models without expertise.

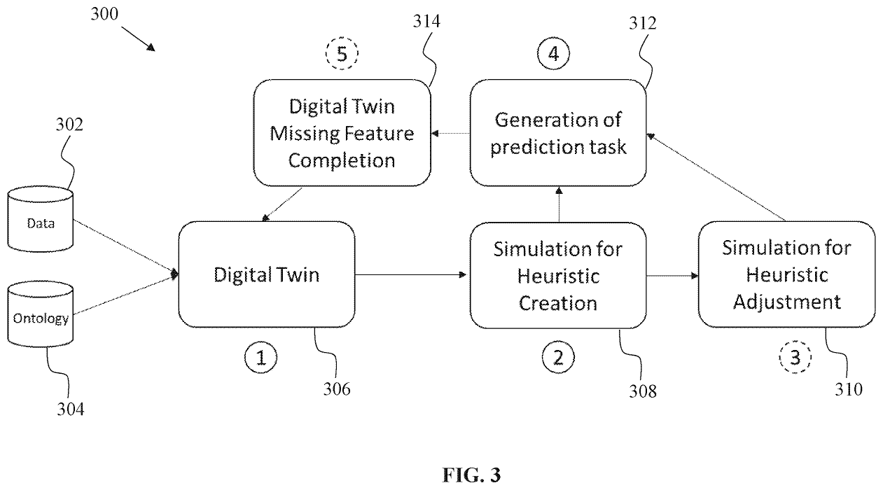

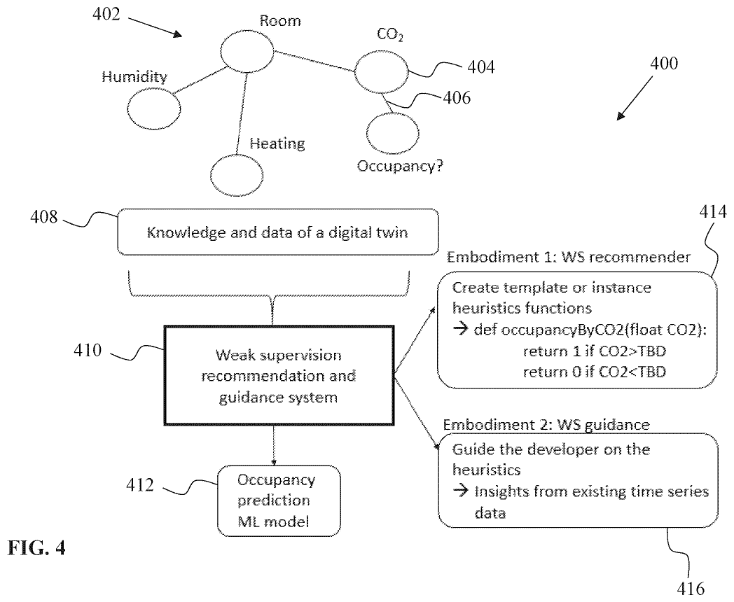

In an embodiment, the present invention provides a system that applies a method of using semantic knowledge and data of a digital twin, which can be any digital representation of any environment/object/entity, for simulation for creating input and output features, and completion of digital twin itself in smart districts, which could be used for different applications. Output features represent situations in the smart districts such as events that are detected in the district (e.g., a safety-related incident or high occupancy/crowdedness). The input features represent the data that is necessary for training machine learning models to identify the situations. FIGS. 3 and 4 schematically illustrate the simulation according to an embodiment of the present invention.

FIG. 3 shows a digital twin simulation according to an embodiment of the present invention which considers simulation of a digital twin for estimating data (features) for smart districts (e.g., to detect certain situations and/or complete missing sensor data). The digital twin missing feature completion is handled through weakly-supervised machine learning.

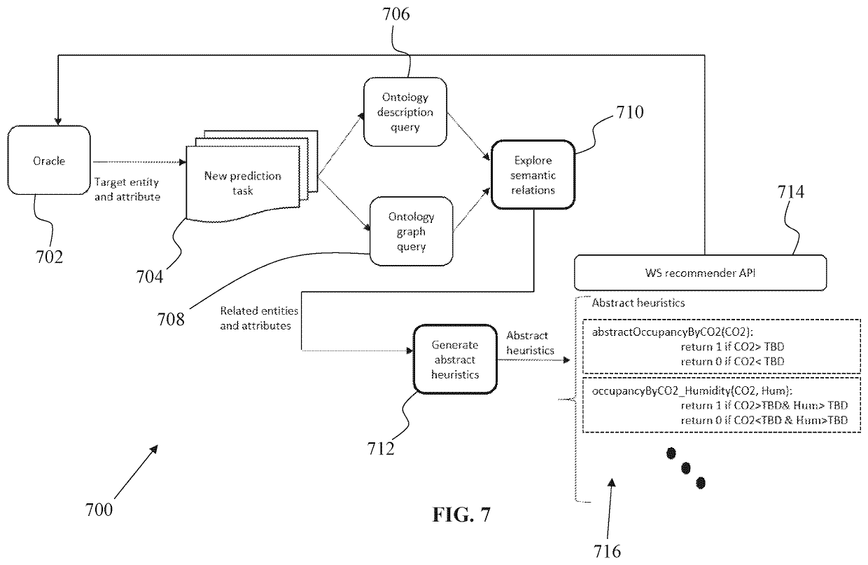

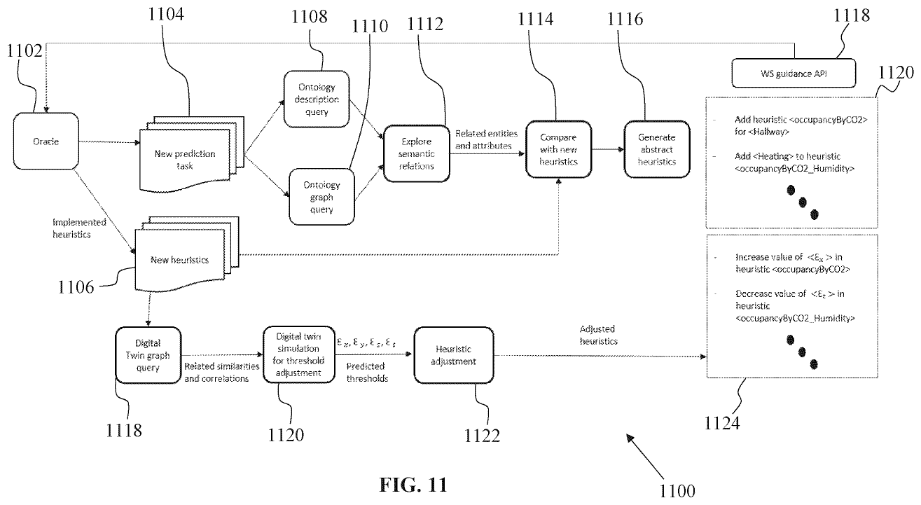

Specifically, a method 300 for digital twin feature completion is illustrated. Data 302 and one or more ontologies 304 are provided to a digital twin 306. The data 302 and one or more ontologies 304 from the digital twin 306 are then automatically used for a simulation for heuristic creation 308. The heuristic creation 308 may include similar features to heuristic creation steps described hereafter with reference to FIG. 7. The simulation for heuristic creation 308 is used to generate a prediction task 312. The generated prediction task 312 is used to update the digital twin by providing features missing from the digital twin, thereby leading to digital twin missing feature completion 314. The digital twin 306 is thus updated and the method 300 can be repeated for further refining the accuracy of the digital twin 306. In some embodiments, after a heuristic is created in step 308, a simulation for heuristic adjustment 310 of the created heuristic can be automatically carried out. The heuristic adjustment 310 may include similar features to heuristic adjustment steps described hereafter with reference to FIG. 11. The adjusted heuristic is then used to generate a prediction task in step 312.

FIG. 4 schematically illustrates a method and system for weak supervision recommendation and guidance according to two exemplary embodiments of the present invention where the simulated scenario is a building. In particular, the system leverages the semantic model and data of a digital twin for two purposes. The semantic model and data can be represented as a graph model that contains nodes, which represent entities, and edges, which represents relationships between the nodes. The semantic model and data can be represented in any other format such as tables or key-value pairs in different implementations. The system would leverage from the available format for the semantic model and data. Although a running example of a building digital twin is used to demonstrate improvements provided by embodiments of the present invention, the method and system according to other embodiments of the present invention can also be practically applied to other simulations using a sematic model and data from another environment, scenario or other state of connected parameters to be simulated.

Specifically, FIG. 4 illustrates a system 400 having a knowledge graph 402 with nodes 404 and relationships 406. Although the illustrated embodiment includes a knowledge graph 402, it will be readily appreciated that other embodiments that include data and relationships in other forms, such as tables or key-value pairs, may also be used. In an exemplary embodiment in which the digital twin models a building as a physical counterpart, the nodes 404 of the knowledge graph may include a variety of parameters relating to the building or rooms of the building, such as a room identifier, humidity level, heating level, carbon dioxide level, and occupancy level, among other possible parameters. The knowledge graph 402 is stored and used within a digital twin implemented in a digital twin system.

Information in the knowledge graph 402 is extracted as knowledge and data of a particular digital twin 408 and provided to a weak supervision recommendation and guidance system 410. The weak supervision recommendation and guidance system uses knowledge and data of the digital twin to update an occupancy prediction machine learning model 412. The weak supervision recommendation and guidance system 410 may, in an embodiment, provide a recommendation or guidance to a weak supervision recommender 414 that creates a heuristic function. The weak supervision recommendation and guidance system 410 may also provide guidance to a weak supervision guidance module 416 that guides a user or developer on heuristics using insights from existing time series data.

Leveraging semantic knowledge automatically by the proposed system would not only improve the accuracy of the weakly-supervised machine learning for a target prediction (graph completion) task, but also relieve the developers from the substantial effort of creating heuristic functions from scratch. Both embodiments, for recommendation and for guidance of weak supervision, provide these improvements for the target predictions of certain situations for the digital twins. The system implements the two embodiments for weak supervision.

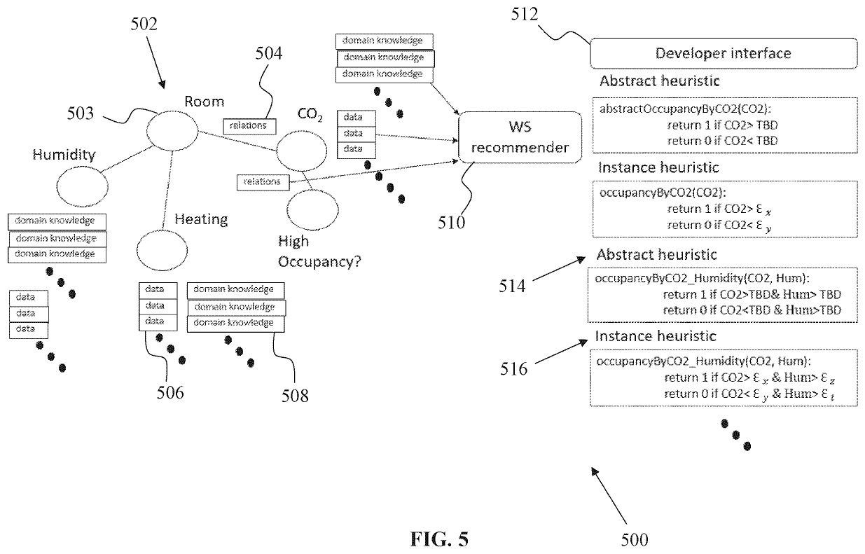

Referring to FIG. 5, a weak supervision recommender according to an embodiment of the present invention leverages all available information in the semantic model and the data itself and implements a method to recommend heuristics to the developers. Developers can be data scientists, domain experts, programmers or even people who do not have any programming experience. The system implements a developer interface based on the knowledge of the developer to recommend either “abstract heuristics” or “instance heuristics”, which are functions that make a prediction for a target value. As an example for the target value, assuming high occupancy information is not known, the function may predict existence of high occupancy in a building for a given time interval. As an example for using the existing semantic models and data, domain knowledge described as text by domain experts, semantic ontologies, or technical reports can be considered, in addition to raw data (e.g., measurements from the sensors). Considering the graph representation of a building digital twin, relationships between all entities such as rooms and deployed sensors as well as the target values can also be defined through sets of “relationships”.

FIG. 5 illustrates a weak supervision recommendation system 500 in which a knowledge graph 502 with a plurality of nodes 503 and relationships 504 is used to provide relationships 504, data 506, and domain knowledge 508 to a weak supervision recommender 510. Similar to knowledge graphs described previously, the knowledge graph 502 includes nodes 503 that each represent a data parameter. The knowledge graph 502 also provides representations of relationships 504 between nodes 503. Each node may include a plurality of data 506 and domain knowledge 508 for a particular parameter. For example, a parameter with regard to humidity may store time-series data regarding the humidity of a particular room, and the knowledge graph 502 would thus establish a relationship 504 between the particular room node 503 and the humidity node 503 to which it is related. The data 506, domain knowledge 508, and relationships 504 of the knowledge graph 502 are provided to a weak supervision recommender 510. The weak supervision recommender 510 recommends or creates heuristics via a developer interface 512. For example, the weak supervision recommender 510 may create an abstract heuristic 514 and/or an instance heuristic 516 and recommend them to a user via the developer interface 512.

The system uses the semantic models and data to first provide a set of abstract heuristics, which includes inputs, outputs, and a logical component where the logic is already implemented, whereas the values (e.g., expected sensor measurements) are left as to be determined and posed to the developer. Second, the system uses the semantic models and data (semantic graph) to provide a set of instance heuristics, which includes inputs, outputs and a logical component where the logic is already implemented, whereas the values (e.g., expected sensor measurements) are also recommended by the system. These values can be either accepted or changed by the developer through the developer interface. FIG. 5 illustrates the creation of abstract and instance heuristic functions based on the semantic knowledge graph as well as the resulting developer interface. In contrast to an approach that considers recommending heuristic functions to a developer which relies on the existence of some ground-truth labels, embodiments of the present invention provide a recommendation method which does not require to use any ground-truth, and leverages the semantic graph to create the abstract or instance heuristic functions.

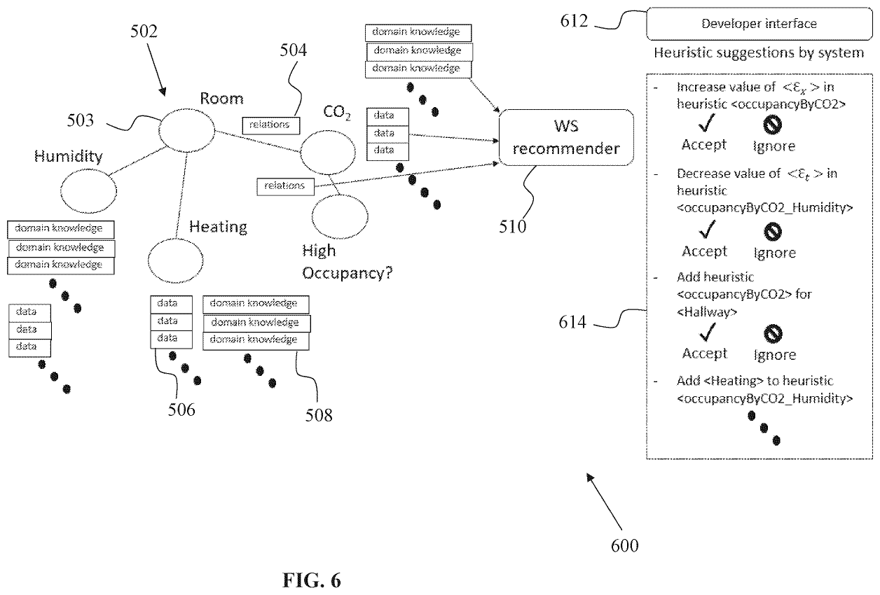

Referring to FIG. 6, a method and system for weak supervision guidance according to an embodiment of the present invention is based on the semantic knowledge and data that is represented in the semantic model. Similar to the embodiment of FIG. 5, domain knowledge, data (e.g., sensor measurements), as well as all the relationships, are used by the “WS guidance” component of the system to provide suggestions to the developer. In addition to this knowledge, the WS guidance component also examines the existing heuristics that are created either by the developers or by the system itself (through the embodiment of FIG. 5). The suggestions are varied and many possibilities exist to improve the weak supervision (e.g., changing threshold values that are incorporated in the logic that is implemented by the existing heuristic functions such as changing a threshold < [symbol] > for CO₂ in a heuristic that predicts high occupancy situations). Furthermore, WS guidance can guide the developer for writing new heuristics based on the existing ones (e.g., add heuristic <occupancyByCO₂>, also to the other rooms), or adding new data sources to the existing heuristic functions (e.g., add <Heating> to the existing heuristic that uses only CO₂ and humidity). Below are two additional examples.

FIG. 6 illustrates a weak supervision recommendation system 600 in which a knowledge graph 502 with a plurality of nodes 503 and relationships 504 is used to provide relationships 504, data 506, and domain knowledge 508 to a weak supervision recommender 510. Although the weak supervision recommendation system 600 bears some similarities to the system illustrated in FIG. 5, different heuristic suggestions 614 may be made by a developer interface 612 to a user. For example, the weak supervision recommender 510 may provide a suggestion to adjust a heuristic function, such as by increasing or decreasing values of a parameter in a heuristic function. Furthermore, the weak supervision recommender 510 may provide a suggestion to add a new parameter to a heuristic function. The heuristic suggestions 614 illustrated in FIG. 6 provide a user with an option to either accept or heuristic suggestions for adjusting a heuristic function. In some embodiments, a user may be provided with additional options, such as the ability to change parameter values, value ranges, or the particular parameter added to a heuristic function.

Example 1: Developer created CO₂ function for a room A, the system suggests to use the CO₂ measurements also same for another room B, that is already available in the room B.

Example 2: Developer tries to use the same CO₂ thresholds for two different rooms, room C and room D, the system proposes to change because the system knows that room D is a large conference room, not a small lecture room as is the case for room C.

These are just examples, whereas in practice there would be many different guidance suggestions to the developers that could be provided for adjusting or fine-tuning the heuristic functions. This guidance provides to improve the precision and accuracy of the functions as well as other metrics such as coverage of the heuristics considering the unlabeled dataset.

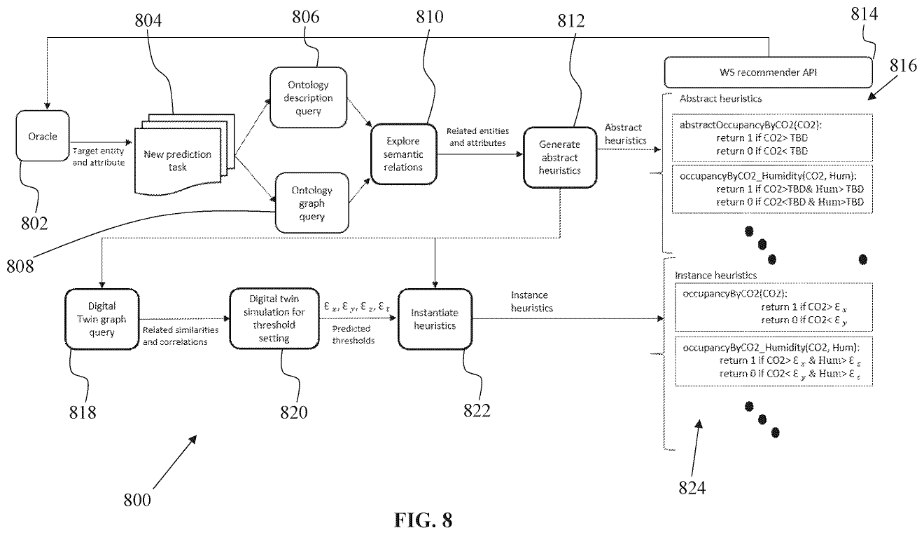

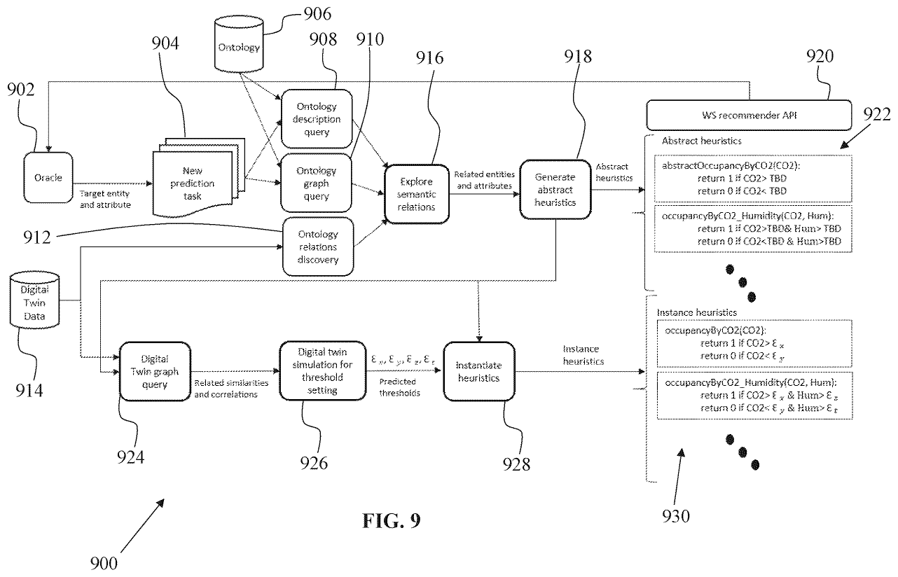

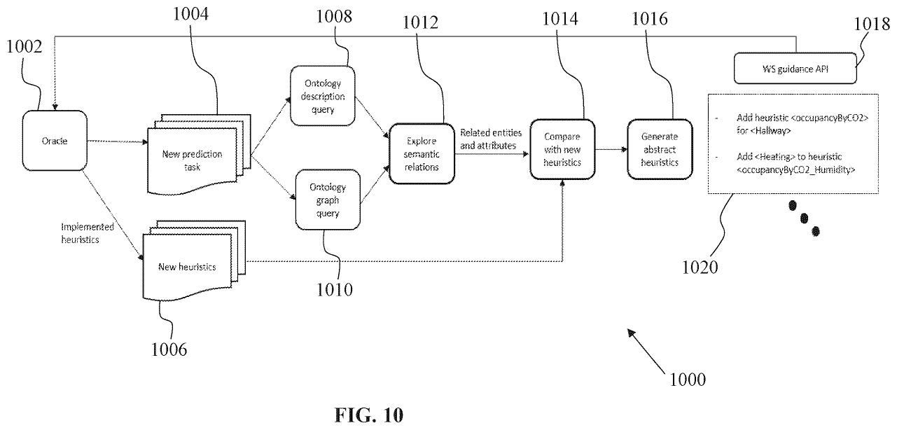

Referring to FIG. 7, a system architecture 700 for semantic weak supervision pipeline according to an embodiment of the present invention provides for several methods. In particular, the methods provided for using the semantic weak supervision pipeline according to embodiments of the present invention include: a method for generating abstract heuristic functions (e.g., FIG. 7), a method for instantiation of heuristic functions (e.g., FIG. 8), a method for generating heuristics by data-driven relations discovery (e.g., FIG. 9), a method for guidance of the heuristic functions by generation of abstract heuristics (e.g., FIG. 10), and a method for guidance of the heuristic function adjustments (e.g., FIG. 11).

The system architecture 700 illustrated in FIG. 7 includes an Oracle 702 via which target entity and attribute data is provided to create one or more new prediction tasks 704.

The target entity and attribute could represent a target situation, for example, in a smart district, smart city, smart hospital, medical application, or another feature with missing values that are to be estimated downstream in the system pipeline. The one or more new prediction tasks 704 are then queried. An ontology description query 706 returns ontology descriptions, such as ontology-related metadata and entities and attributes. An ontology graph query 708 returns relevant ontology, which may be in the form of a graph or subgraph, for the given entity and attribute of the one or more new prediction tasks 704. The graph or subgraph may include entities, attributes, and relationships. The result of each of the ontology description query 706 and the ontology graph query 708 is used to explore semantic relations 710, the result being related entities and attributes that can be used to generate abstract heuristics 712. A weak supervision recommender application programming interface 714 provides created heuristics 716, to a user. In the illustrated embodiment of FIG. 7, created heuristics 716 include a plurality of abstract heuristics.

An embodiment of a method for generating abstract heuristic functions according to an embodiment of the present invention comprises the following steps (from left to right in FIG. 7):
1. Receive prediction task (a target entity and attribute) via Oracle 702 and add into the pipeline. The target entity and attribute could represent, e.g., a target situation in smart district or a feature with missing values (to be predicted).
2. New prediction task 704 is added to the pipeline.
3. The entity and attribute is queried from the ontology.
   a. Ontology graph query 708 returns the relevant ontology graph/subgraph for the given entity and attribute. The graph includes (but may not be limited to) entities, attributes, relationships.
   b. Ontology description query 706 returns the ontology descriptions (ontology-related metadata about the entities and attributes).
4. The results from step 3.a. and step 3.b. are used to explore semantic relations 710 given the ontology graph and ontology descriptions. Exploration of semantic relations 710 can be carried out according to known methods (see Christos Koutras, George Siachamis, Andra Ionescu, Kyriakos Psarakis, Jerry Brons, Marios Fragkoulis, Christoph Lofi, Angela Bonifati, and Asterios Katsifodimos, “Valentine: Evaluating Matching Techniques for Dataset Discover,” arXiv:2010.07386v2 (2021), which is hereby incorporated by reference herein). The relevant entities and attributes are output as a result of this step. For example:
   a. The relevant entities and attributes are ranked based on their closeness to the target entity and attribute.
   b. The closest entities and/or their attributes are used as the input arguments of a programming function (e.g., a Python function).
   c. The function is filled from a template using input arguments added with cases (e.g., if, else if in Python), in comparison with threshold constants, values of which are to be determined (TBD). The Oracle 702 can fill the TBD values, and the system can instantiate the abstract functions based on the values given by the Oracle 702. The instantiation of abstract functions may include similar features to instantiation of abstract functions described hereafter with reference to FIG. 8.
   d. The comparison cases (e.g., if/else) and TBD values are presented to the weak supervision (WS) recommender application processing interface (API) 714.
5. The relevant entities and attributes are used to create abstract heuristic functions 712.
6. The WS recommender API 714 presents the generated abstract heuristic functions 716.

Advantages of this method include that there is no need for a human to explore ontology or descriptions to find out relevant entities and attributes, and heuristic functions are generated automatically.

An embodiment of a method 800 for creating instantiated heuristic functions according to an embodiment of the present invention comprises the following steps (from left to right in FIG. 8):
1. Oracle 802 defines prediction task by stating a target entity and attribute.
2. New prediction task 804 is added into the pipeline.
3. The entity and attribute is queried from the ontology.
   a. Ontology graph query 808 returns the relevant ontology graph/subgraph for the given entity and attribute. The graph includes (but may not be limited to) entities, attributes, relationships.
   b. Ontology description query 806 returns the ontology descriptions (ontology-related metadata about the entities and attributes)
4. The results from step 3.a. and step 3.b. are used to explore semantic relations 810 given the ontology graph and ontology descriptions. The relevant entities and attributes are output as a result of this step.
5. The relevant entities and attributes are used to create abstract heuristic functions 812.
6. Abstract heuristics (outputs of step 4. and step 5.) are used to query an existing “Digital Twin” graph 818, which comprises values of given entities/attributes. The values of the Digital Twin graph can represent real-world measurements (e.g., sensor reading values on a time-scale) or values that are created virtually (e.g., analytical values or simulation values of virtual agents).
7. The related similarities and correlations are explored by training a machine learning model via digital twin simulation for threshold setting 820. The abstract heuristic functions that are given in step 5 (e.g., step 812 of FIG. 8) are matched with the outputs of step 6 (e.g., step 818 of FIG. 8), such that the TBD values are set with predicted thresholds { [symbol] _x, [symbol] _y, [symbol] _z, [symbol] _t, . . . } , so that the instance functions are created 822. For example:
   a. The values of the relevant entities/attributes are taken from the Digital Twin graph with the relevance metrics (e.g., scores or ranking).
   b. A machine learning model is trained to predict relevant attributes using the input the data from the Digital Twin graph and inputs/outputs given in the abstract heuristic functions 816.
   c. The machine learning predicts the threshold values { [symbol] _x, [symbol] _y, [symbol] _z, [symbol] _t, . . . } using the trained machine learning model for predictions/estimations and relevant attributes feed into it.
8. WS recommender API 814 presents the instance functions to the Oracle 802.

Accordingly, step 7. utilizes learning from the Digital Twin graph (e.g., using available similar data for similar entities/attributes) and applying the learning for threshold prediction. The predicted values can be still manually adjusted by the Oracle 802, especially in the cases where the Oracle 802 has further domain expertise. In such embodiments, the instantiation method would complement the Oracle's expertise to improve accuracy by providing for either for the non-existing thresholds or by proposing initial threshold values.

Advantages of this method are listed as follows include that there is no need for a human to set the thresholds values from scratch, it is not necessary to have a domain expert as the system automatically sets the threshold values, and there is no need for a human to understand logical comparisons between various entities and their attributes.

FIG. 9 illustrates a system architecture 900 of a method for generating heuristics by data-driven relations discovery. In this embodiment, the available ontology does not comprise latent semantic relations. This can happen because it is a hard task for a domain expert to make an ontology definition exhaustive. In addition, domain experts might not know some latent relations. In other embodiments, latent relations exist only in specific environment.

In FIG. 9, an Oracle 902 provides target entity and attributes to create one or more new prediction tasks 904 in the pipeline. An ontology description query 908 and an ontology graph query 910 are used to query the one or more new prediction tasks 904 and stored ontology data 906 to explore semantic relations 916. Digital twin data 914 is also used to discover ontology relations 912 and explore semantic relations 916. Related entities and attributes are then used to generate abstract heuristics 918, which may be used, to provide abstract heuristics 922 to a user via a weak supervision API 920, to provide abstract heuristics to a digital twin graph query 925, and to instantiate heuristics 928. The instantiated heuristics 928 are used to create instance heuristics recommendations 930. Related similarities and correlations from digital twin graph query 924 are used to perform a digital twin simulation for a threshold setting 926, thereby making threshold predictions that can be used to instantiate heuristics in step 928.

For generating heuristics by data-driven relations discovery, latent relations can be discovered based on the available digital twin data. Correlations between digital twin attributes are learned from the data. Based on the discovered relations, the system can generate new heuristics. In some other embodiments, the system might discover latent relations among digital twin types. In other embodiments, the latent relations to be discovered are among different digital twin instances. For example, the system can generate heuristics for DigitalTwinA and that use attributes from DigitalTwinB.

Referring to FIG. 10, an embodiment of a method 1000 for guidance of the heuristic functions by generation of abstract heuristics (e.g., a method for guidance of an Oracle by new heuristics) comprises the following steps (from left to right in FIG. 10):
1. Oracle 1002 defines prediction task by stating a target entity and attribute. At the same time, the Oracle 1002 provides initial heuristic functions. The Oracle 1002 may be a repository storing functions, and providing initial heuristic functions may include querying such a repository.
2. New prediction task 1004, 1006 and the initial heuristic functions are added into the pipeline.
3. The entity and attribute is queried from the ontology.
   a. Ontology graph query 1010 returns the relevant ontology graph/subgraph for the given entity and attribute. The graph includes (but may not be limited to) entities, attributes, relationships.
   b. Ontology description query 1008 returns the ontology descriptions (ontology-related metadata about the entities and attributes).
4. The results from step 3.a. and step 3.b. is used to explore semantic relations 1012 given the ontology graph and ontology descriptions. The relevant entities and attributes are output as a result of this step.
5. In a new step, the results from step 4. are used to compare with “new heuristics” 1014 that are initially provided by the Oracle 1002. The comparison may be carried out based on function declarations comprising input and output variables together with logic and/or text. Specifically, the comparison may include comparing the output of functions given the same input being provided to each of the functions. Alternatively or in addition, a decision tree can be built for each function and the resulting trees can then be compared. The comparison outputs from this step can guide the step 4. to explore unexplored areas in the semantic ontology. In one embodiment, the semantic exploration outputs can be filtered based on the already existing heuristics. In another embodiment, this step implements various comparison metrics to apply in the semantic exploration, to be considered for the future step of heuristic generation. In another embodiment, this step can be used to guide the semantic exploration in step 4 (e.g., step 1012 of FIG. 10) for exploring entities/attributes that were not previously considered by the Oracle 1002 in the “new heuristics”.
6. The relevant entities and attributes that are not initially covered by the Oracle in the initial heuristics are used to generate new abstract heuristic functions 1016 in addition to the existing heuristic functions.
7. Weak supervision guidance API 1018 presents the new abstract functions 1020 to the Oracle 1002. The Oracle 1002 can decide to include new heuristics or not include them. Similarly, the Oracle 1002 can decide replacing the initial heuristics with the proposed abstract heuristics 1020.

The pipeline can run in an iterative mode (from step 7 back to step 1 for generating “new heuristics”). Thus, the Oracle 1002 advantageously can only initially provide a small set of heuristics, then can propose new ones based on the received recommendations. Further recommendations can be given by the system to the Oracle at the end of the iterations.

Advantages of this method include that heuristic functions are generated automatically, the Oracle 1002 may use the system iteratively to receive feedbacks/guidance during generation of heuristic functions, and the system can complement the lack of domain knowledge or knowledge of semantic ontology by exploring the entities/attributes that were not considered by the Oracle 1002.

Referring to FIG. 11, an embodiment of a method 1100 for guidance of the heuristic function adjustments (e.g., a method for guidance of an Oracle 1102 by heuristic adjustments) comprises of the following steps (from left to right in the FIG. 11):
1. Oracle 1102 defines one or more prediction tasks 1104 by stating a target entity and attribute. At the same time, the Oracle 1102 provides initial heuristic functions 1106.
2. The prediction task 1106 and the initial heuristic functions are used to query an existing Digital Twin graph 1118, which comprises values of given entities/attributes.
3. The related similarities and correlations are explored by training a machine learning model via digital twin simulation for threshold adjustment 1120. The heuristic functions 1106 that are given in step 1. are compared with the outputs of this step. For example, existing threshold values in the “new heuristics” are compared with predicted thresholds { [symbol] _x, [symbol] _y, [symbol] _z, [symbol] _t, . . . }. If the existing threshold values and the predicted threshold values differ significantly, threshold adjustments based on the predicted values may be proposed.
4. The system decides on a need for heuristic adjustment proposal 1122 for certain existing heuristics. For example, this step can be implemented such that when the machine learning model in step 3 (e.g., step 1120 of FIG. 11) has high confidence (e.g., very small uncertainty) and the predicted threshold [symbol] _x has a substantial mismatch to the given threshold by the Oracle 1102, the heuristic adjustment is proposed by the system.
5. The adjusted heuristics 1124 are presented to the Oracle 1102 by the Weak supervision guidance API 1118.

It will be readily understood that the method and system as described above with reference to FIG. 11 can be implemented in addition to the method and system described with reference to FIG. 10. For example, FIG. 11 can include one or more new prediction tasks 1104, an ontology description and graph query 1108, 1110, exploration of semantic relations 1112, comparison of related entities and attributes with new heuristic functions 1114, and generation of abstract heuristic functions 1116, much in the same manner as described above with reference to FIG. 10. As a result, the weak supervision guidance API 1118 may provide both proposed abstract heuristics 1120 and adjusted heuristics 1124 to a user and to Oracle 1102.

Similar to the guidance by new heuristic generation, the pipeline can run in an iterative mode (from step 5. back to step 1. for adjusting heuristics). Thus, the Oracle initially provides a set of heuristics, then adjusts or does not adjust based on the received recommendations. Further recommendations can be given by the system to the Oracle at the end of the iterations.

Advantages of this method include that the system can work with heuristics functions that are not very accurate, as such heuristics function can be adjusted by a data-driven approach, and the Oracle may use the system iteratively to receive feedbacks/guidance during adjustment of the provided heuristic functions.

The methods according to embodiments of the present invention can be used separately or in combination to implement a semantic weak supervision guidance pipeline. Each method can be implemented using different machine learning algorithms, semantic ontologies, and/or digital twin frameworks based on the design choices.

In an embodiment, the present invention provides for application of semantic guidance for high occupancy prediction using building digital twins. This embodiment practically applies the weak supervision system according to an embodiment of the present invention for understanding high occupancy situations in smart buildings. Understanding and being able to predict high occupancy situations improves dynamic control of heating, ventilation, and air conditioning (HVAC) in the smart buildings, in particular improving the HVAC control and its benefits for energy savings. For example, a developer M, can decide to create a prediction model for understanding high-occupancy and controlling HVAC based on the occupancy situations.

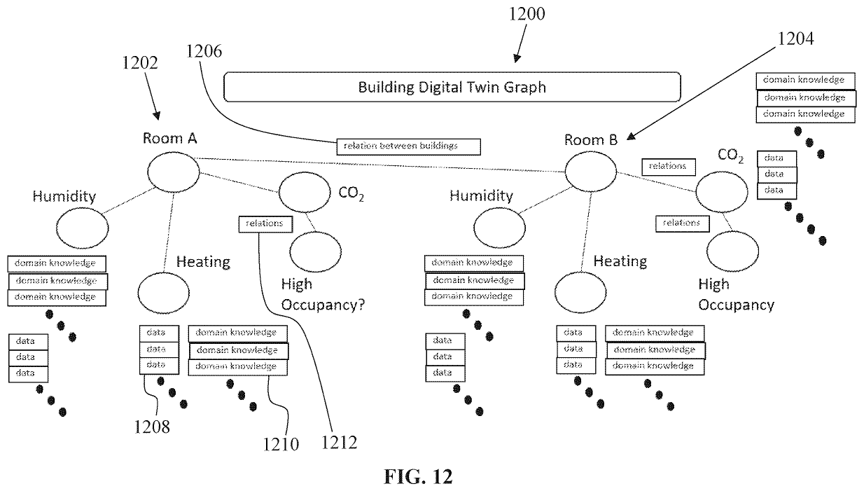

FIG. 12 shows an example semantic graph 1200 for the smart building, where only two rooms, room A 1202 and room B 1204, are shown for simplicity and ease of explanation. Each room has similar characteristics and sensors such as CO2 and humidity. The rooms 1202, 1204 contain a set of relationships 1206 based on their similarities/differences. This embodiment considers the developer M as the developer who needs to create a high-occupancy prediction for both rooms, room A 1202 and room B 1204, using the available data.

With existing technology, developer M can only use an already existing weak supervision platform such as Snorkel as proposed by Alexander J. Ratner et al. for programming their application for high occupancy prediction. To create the application using the existing weak supervision systems, developer M has to understand all the available datasets for the smart building rooms, including all characteristic data 1208, domain knowledge 1210, and relationships 1212 between characteristics. For instance, the developer M needs to download data files (e.g., CSV files) and pre-process them to access all available datasets. Furthermore, the developer M needs to understand existing features in all of the datasets. After accessing all features, developer M needs to understand which features can be useful for high-occupancy predictions for which environments (e.g., neighbor rooms, hallways, etc.). Moreover, developer M needs to understand the correlations between different features and apply preprocessing to avoid creating heuristics for highly-dependent data features. The aforementioned tasks are minimum requirements for the developer M to start creating and testing heuristic functions, which alone consume large amounts of computational resources, and are time intensive for the developer M, as well as prone to errors. Lastly, developer M would need to try implementing various logic as heuristics. After finishing at least all the tasks and training a machine learning model, developer M can have a prediction model for room A 1202. However, since room B 1204 would also need a prediction model for its high occupancy situations, developer M would need to do the above tasks also for the Room B 1204. These minimal set of tasks require not only creativity based on the understanding of the dataset and domain competence, but also time and effort of the developer, who would need to have good programming knowledge.

In contrast, embodiments of the present invention leverage the semantic knowledge to relieve developer M from these tasks by: automatically recommending abstract and instance heuristics and proposing these to the developer (see FIG. 5); and/or automatically guiding the developer by suggestions to adjust the existing heuristic functions (see FIG. 6).

The system also helps to provide for transfer of the models between different rooms, as it learns knowledge from the semantic models and data, as well as the heuristics that are already implemented in similar rooms. Thus, embodiments of the present invention enable transferring the model from one room to another (e.g., transfer of heuristics from room A 1202 to room B 1204). Using existing technology, transfer of a model from one building to another would not be straight-forward for a developer since the developer would needs to understand which features are still applicable and which features correlate, which is a technically challenging task that is time and resource intensive, both in terms of computational and human resources. Since developer M would still have the capability to create new heuristics from scratch, embodiments of the present invention could also be used complementary to existing approaches to reduce development time and costs, and to save computational and expert time and resources. Further, using embodiments of the present invention, developer M does not need to be an expert or data scientist, and does not need to really work with features, instead developer M can be provided with the heuristics with relevant features.

It will be readily understood that the specific application of embodiments of the present invention as illustrated in FIG. 12 with reference to smart buildings can also be implemented in a variety of other applications. For example, embodiments of the present invention can be applied in the medical field to provide methods monitoring rooms or equipment in hospitals, for predicting the length of stay of patients in hospitals, or for digital twin systems used to model medical treatments and drug or vaccine development. Likewise, it will be readily understood that the advantages associated with implementing embodiments of the present invention in smart building digital twin systems can also be achieved in other digital twin systems.

Accordingly, embodiments of the present invention enable creating and adjusting heuristics. In a further embodiment, these heuristics are used for the purpose of digital twin graph completion. Here, the heuristics can be taken by a weakly-supervised machine learning model for any missing features/data in the digital twin graph. The targets can be specified by the Oracle based on needs of the smart district applications.

In an embodiment, the present invention provides a method and system for digital twin-guided machine learning, e.g., for smart districts, the method comprising:
1. Mapping of the data to the semantic knowledge in the digital twin graph.
2. Digital twin processing to learn heuristic creation/adjustment from semantic knowledge and raw data (and, if available, existing heuristic functions).
3. (In an embodiment, if input to system desired) Application interface proposing abstract heuristics and recommend or guide possible instantiation of the heuristics.
4. Apply weakly-supervised machine learning for prediction tasks.
5. (In an embodiment, if completion of missing information is desired) Completion of digital twin information with weakly-supervised machine learning.

Embodiments of the present invention provide for the following improvements over existing technology:
1. Predicting missing values in digital twins from knowledge and raw data of the digital twins by exploring semantic relations in the knowledge and correlations in the digital twin data.
2. Iterative exploration and completion of missing knowledge of a digital twin through weakly-supervised machine learning
3. Improved HVAC control and energy savings because of better prediction models in terms of applicability, determined interrelationships and accuracy.
4. Reduced deployment and computational costs because of the automatic generation of heuristics.
5. Reduced bandwidth usage by sensor devices.

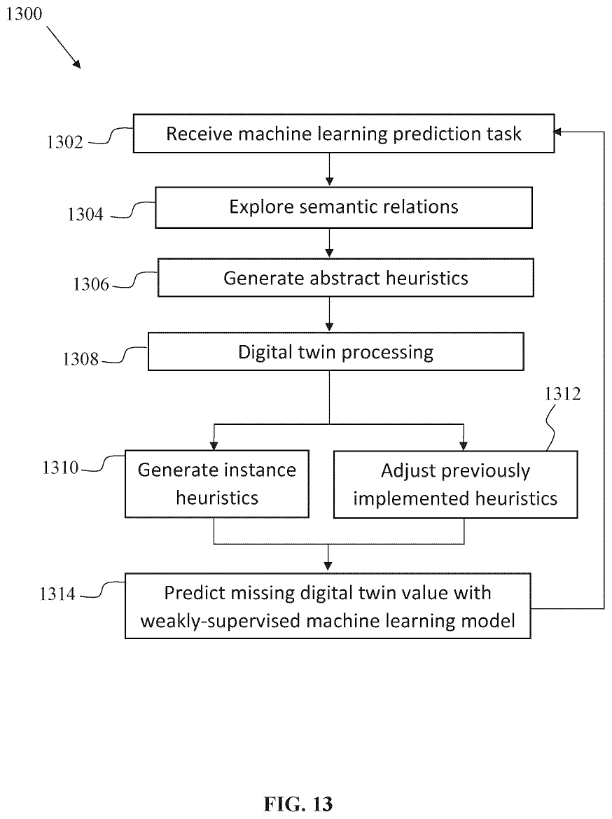

Referring to FIG. 13 a method 1300 for predicting missing digital twin values with a weakly-supervised machine learning model is illustrated. The method 1300 comprises receiving a machine learning prediction task 1302, the prediction task 1302 including a target entity and attribute. Next, semantic relations are explored 1304 to generate relevant entities and attributes related to the target entity and attribute. Abstract heuristic functions are then generated 1306 based on the relevant entities and attributes and filling a programming function from a template with cases in comparison to values that are to be determined. Digital twin processing 1308 is then performed. Methods for carrying out digital twin processing include the methods described above, for example, in connection with FIGS. 8, 9, and 11. The digital twin processing 1308 may be used either to generate instance heuristics 1310 or to adjust previously implemented heuristics 1312. In the case of generating instance heuristics 1310, digital twin processing 1308 includes using a weakly-supervised machine learning model to predict entities and attributes in the digital twin that are related to the relevant entities and attributes that are generated via exploring semantic relations 1304. The weakly-supervised machine learning model then determines predicted threshold values, the predicted threshold values replacing the to be determined values of the abstract heuristic functions to generate instance heuristics functions. 1310. In some embodiments, a previously implemented heuristic is instead adjusted 1312 by comparing threshold values of the previously implemented heuristic with the predicted threshold values. The generated and/or adjusted heuristics are then used to predict missing digital twin values with a weakly-supervised machine learning model 1314. This sequence of steps can be repeated until all missing digital twin values are predicted and the digital twin is complete with filled-in predicted values in place of all missing values. Specifically, after a missing value of a digital twin is predicted 1314, a new machine learning prediction task may be received 1302 for a new entity and attribute to fill another missing value of the digital twin.

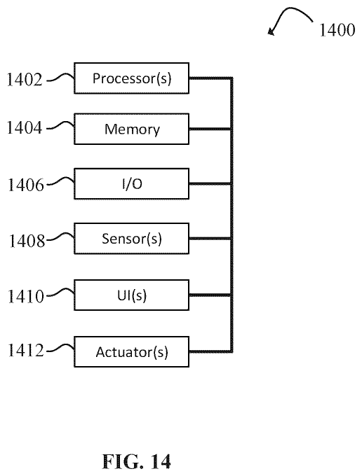

Referring to FIG. 14, a processing system 1400 can include one or more processors 1402, memory 1404, one or more input/output devices 1406, one or more sensors 1408, one or more user interfaces 1410, and one or more actuators 1412. Processing system 1400 can be representative of each computing system disclosed herein.

Processors 1402 can include one or more distinct processors, each having one or more cores. Each of the distinct processors can have the same or different structure. Processors 1402 can include one or more central processing units (CPUs), one or more graphics processing units (GPUS), circuitry (e.g., application specific integrated circuits (ASICs)), digital signal processors (DSPs), and the like. Processors 1402 can be mounted to a common substrate or to multiple different substrates.

Processors 1402 are configured to perform a certain function, method, or operation (e.g., are configured to provide for performance of a function, method, or operation) at least when one of the one or more of the distinct processors is capable of performing operations embodying the function, method, or operation. Processors 1402 can perform operations embodying the function, method, or operation by, for example, executing code (e.g., interpreting scripts) stored on memory 1404 and/or trafficking data through one or more ASICs. Processors 1402, and thus processing system 1400, can be configured to perform, automatically, any and all functions, methods, and operations disclosed herein. Therefore, processing system 1400 can be configured to implement any of (e.g., all of) the protocols, devices, mechanisms, systems, and methods described herein.

For example, when the present disclosure states that a method or device performs task “X” (or that task “X” is performed), such a statement should be understood to disclose that processing system 1400 can be configured to perform task “X”. Processing system 1400 is configured to perform a function, method, or operation at least when processors 1402 are configured to do the same.

Memory 1404 can include volatile memory, non-volatile memory, and any other medium capable of storing data. Each of the volatile memory, non-volatile memory, and any other type of memory can include multiple different memory devices, located at multiple distinct locations and each having a different structure. Memory 1404 can include remotely hosted (e.g., cloud) storage.

Examples of memory 1404 include a non-transitory computer-readable media such as RAM, ROM, flash memory, EEPROM, any kind of optical storage disk such as a DVD, a Blu-Ray® disc, magnetic storage, holographic storage, a HDD, a SSD, any medium that can be used to store program code in the form of instructions or data structures, and the like. Any and all of the methods, functions, and operations described herein can be fully embodied in the form of tangible and/or non-transitory machine-readable code (e.g., interpretable scripts) saved in memory 1404.

Input-output devices 1406 can include any component for trafficking data such as ports, antennas (i.e., transceivers), printed conductive paths, and the like. Input-output devices 1406 can enable wired communication via USB®, DisplayPort®, HDMI®, Ethernet, and the like. Input-output devices 1406 can enable electronic, optical, magnetic, and holographic, communication with suitable memory 1406. Input-output devices 1406 can enable wireless communication via WiFi®, Bluetooth®, cellular (e.g., LTE®, CDMA®, GSM®, WiMax®, NFC®), GPS, and the like. Input-output devices 1406 can include wired and/or wireless communication pathways.

Sensors 1408 can capture physical measurements of environment and report the same to processors 1402. User interface 1410 can include displays, physical buttons, speakers, microphones, keyboards, and the like. Actuators 1412 can enable processors 1402 to control mechanical forces.

Processing system 1400 can be distributed. For example, some components of processing system 1400 can reside in a remote hosted network service (e.g., a cloud computing environment) while other components of processing system 1400 can reside in a local computing system. Processing system 1400 can have a modular design where certain modules include a plurality of the features/functions shown in FIG. 15. For example, I/O modules can include volatile memory and one or more processors. As another example, individual processor modules can include read-only-memory and/or local caches.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1: A computer-implemented method for generating and/or adjusting a heuristic function for a machine learning prediction, comprising:
receiving a machine learning prediction task including a target entity and attribute;
exploring semantic relations to generate relevant entities and attributes related to the target entity and attribute; and
generating and/or adjusting the heuristic function based on the relevant entities and attributes.

2: The method of claim 1, wherein the semantic relations are explored using an ontology graph comprising entities, attributes and relationships, and ontology descriptions of the entities and attributes in the ontology graph.

3: The method of claim 2, wherein the relevant entities and attributes are used to create abstract heuristic functions comprising to be determined values that are presented to a weak supervision recommender application programming interface (API) by the following steps:
ranking the relevant entities and attributes based on distance from the target entity and attribute;
using closest ones of the relevant entities and attributes as input arguments of a programming function;
filling the programming function from a template using the input arguments added with cases in comparison with the to be determined values; and
presenting the cases and the to be determined values to the weak supervision recommender API.

4: The method of claim 3, further comprising receiving values for the to be determined values, and instantiating the abstract heuristic functions as instance heuristic functions using the received values, and wherein the method is repeated to determine a plurality of the instance heuristic functions which provide initial predictions combined by a machine learning model to make the machine learning prediction.

5: The method of claim 3, further comprising using the relevant entities and attributes to query a digital twin graph and outputting results of the query to a machine learning model trained to predict entities and attributes related to the relevant entities and attributes, and instantiating the abstract heuristic functions as instance heuristic functions using predicted thresholds from the machine learning model and replacing the to be determined values with the predicted thresholds, wherein the digital twin graph includes data from a digital twin comprising measurements obtained from one or more sensors.

6: The method of claim 3, wherein the weak supervision recommender API is configured to allow a user to accept or reject the abstract heuristics, or to fill in the to be determined values.

7: The method of claim 1, further comprising:
receiving previously implemented heuristics with threshold values;
comparing the threshold values of the previously implemented heuristics with predicted threshold values determined using digital twin processing with the relevant entities and attributes; and
adjusting the previously implemented heuristics based on the comparison of the threshold values of the previously implemented heuristics with the predicted threshold values.

8: The method of claim 1, wherein the generated and/or adjusted heuristic function is an instance heuristic function used by a weakly-supervised machine learning model to predict a missing value of a digital twin.

9: The method of claim 8, wherein the missing value of the digital twin is filled in with the prediction, and wherein the method is iteratively repeated until all missing values of the digital twin have been predicted and filled in.

10: The method of claim 1, wherein generating and/or adjusting the heuristic function is based on data from a digital twin.

11: The method of claim 10, wherein the data from the digital twin includes measurements received from sensors of a smart building and the machine learning prediction is for one or more of an occupancy, temperature, humidity, carbon dioxide level, and heating level of one or more rooms of the smart building.

12: The method of claim 1, further comprising:
receiving previously implemented heuristics;
comparing entities and attributes of the previously implemented heuristics with the relevant entities and attributes; and
generating adjusted heuristics based on the comparison of the entities and attributes of the previously implemented heuristics with the relevant entities and attributes.

13: The method of claim 12, wherein comparing the entities and attributes of the previously implemented heuristics with the relevant entities and attributes includes:
building a decision tree for each of the previously implemented heuristics and based on each of the relevant entities and attributes, and
comparing the built decision trees.

14: A computer system comprising one or more processors which, alone or in combination, are configured for generating and/or adjusting a heuristic function for a machine learning prediction by being configured to provide for execution of the following steps:
receiving a machine learning prediction task including a target entity and attribute;
exploring semantic relations to generate relevant entities and attributes related to the target entity and attribute; and
generating and/or adjusting the heuristic function based on the relevant entities and attributes.

15: A tangible, non-transitory computer-readable medium having processor-executable instructions stored thereon, wherein the processor-executable instructions, when executed by one or more processors, facilitate generating and/or adjusting a heuristic function for a machine learning prediction by providing for execution of the following steps:
receiving a machine learning prediction task including a target entity and attribute;
exploring semantic relations to generate relevant entities and attributes related to the target entity and attribute; and
generating and/or adjusting the heuristic function based on the relevant entities and attributes.
